(19) United States
(12) Patent Application Publication
(10) Pub. No.: US 2008/0315984 A1
(43) Pub. Date: Dec. 25, 2008

(54) Thermal Release

(75) Inventor: Thomas Neubauer, Angelbachtal (DE)

Correspondence Address: BUCHANAN, INGERSOLL & ROONEY PC, POST OFFICE BOX 1404, ALEXANDRIA, VA, 22313-1404, US

(73) Assignee: ABB PATENT GMBH, Ladenburg (DE)

(21) Appl. No.: 11/660,945

(22) PCT Filed: Oct. 6, 2005
(86) PCT No.: PCT/EP2005/010748

§ 371 Date: Feb. 23, 2007

(30) Foreign Application Priority Data
Nov. 10, 2004 (DE) 10 2004 054 176.0

(51) Int. Cl. H01H 85/12

(52) U.S. Cl. 337/161

(57) ABSTRACT

The invention relates to a thermal tripping device which is heated indirectly by means of a heating winding and which comprises a release strip made of thermostatic bimetal, a form memory alloy or similar. An insulating intermediate layer is arranged between the heating winding and the release strip and one of the ends of the heating winding is connected to a supply conductor. The heating winding is embodied in an identically meandering manner for all current intensities and is folded about the insulating intermediate layer. In order to modify the resistance of the heating winding for other current intensities, the discharge is connected to a wiring point between the ends of the heating windings.

The invention relates to a tripping strip, which is heated indirectly by means of a heating winding, in accordance with the precharacterizing clause of claim 1.

Tripping strips which are either heated directly or heated indirectly and are produced from a bimetallic strip or from a shape alloy are used as thermal releases for an electrical service switching device, for example a line circuit breaker, motor circuit breaker, etc. In the case of direct tripping, the tripping strip has the current flowing through it, while, in the case of indirect heating, a heating winding is arranged around the tripping strip, which heating winding has current flowing through it and has a specific nonreactive resistance, which is sufficient for heating the tripping strip such that it bends out and permanently opens a latching point in the service switching device. The tripping strip generally does not have current flowing through it.

These releases are generally used for so-called overcurrents, i.e. for currents which are not short-circuit currents and which can flow through the service switching device for a certain amount of time before they need to be switched off.

The invention is concerned with an indirectly heated tripping strip.

Such indirectly heated tripping strips are known in large numbers. Insulation which is in the form of, for example, a glass-fiber bush is wound around the tripping strip itself, i.e. around the bimetallic strip (in this case strips of shape alloy are naturally included). A resistance wire in the form of a round wire or a flat wire is wound around this insulating body or around this insulation, it being possible for one of the ends of the winding to be fixed to the bimetallic strip, while the other end of the winding is connected to an incoming line by means of a braided wire. In this case, the bimetallic strip would be fixed at the end at which the winding is fixed to a fixing point in the switching device.

In another refinement, the incoming power line can be connected at one end of the winding and the outgoing power line can be connected at the other end.

These windings are produced manually, in which case it would also be necessary for different winding shapes to be provided owing to different current levels and different tripping times. Owing to this high degree of variance, there is a great deal of outlay on positioning and mounting and, furthermore, the manufacturing quality fluctuates owing to the high proportion of manual working steps.

The object of the invention is to provide a thermal release which provides a uniform geometry of the heating winding for all tripping requirements.

This object is achieved according to the invention by the features of claim 1.

Accordingly, the heating winding has an identical, meandering design for all current levels and is folded around the intermediate insulating layer and, in order to change the resistance of the heating winding for other current levels, i.e. in order to match the tripping strip to different tripping tasks, the outgoing line is connected to a tapping point between the ends of the heating winding.

Depending on the distance between the tapping point and the connection of the incoming line, different resistances of the winding and therefore different response values for the release can be set, in which case the winding as such is the same for all of these requirements.

This meandering heating winding is produced in a simple manner owing to the fact that a high-resistivity sheet-metal material is stamped; the meandering shape is then folded around the intermediate insulating layer.

In accordance with one further embodiment of the invention, in order to change the heating winding for other current levels, the outgoing line can be connected to the other end of the heating winding, in which case at least two adjacent turns are short-circuited.

These short circuits can either be performed by means of a conductor section or by means of a welded joint.

Further advantageous refinements of the invention are described in the further dependent claims.

The invention and further advantageous refinements and improvements of the invention will be explained and described in more detail with reference to the drawing, in which a few exemplary embodiments of the invention are illustrated and in which:

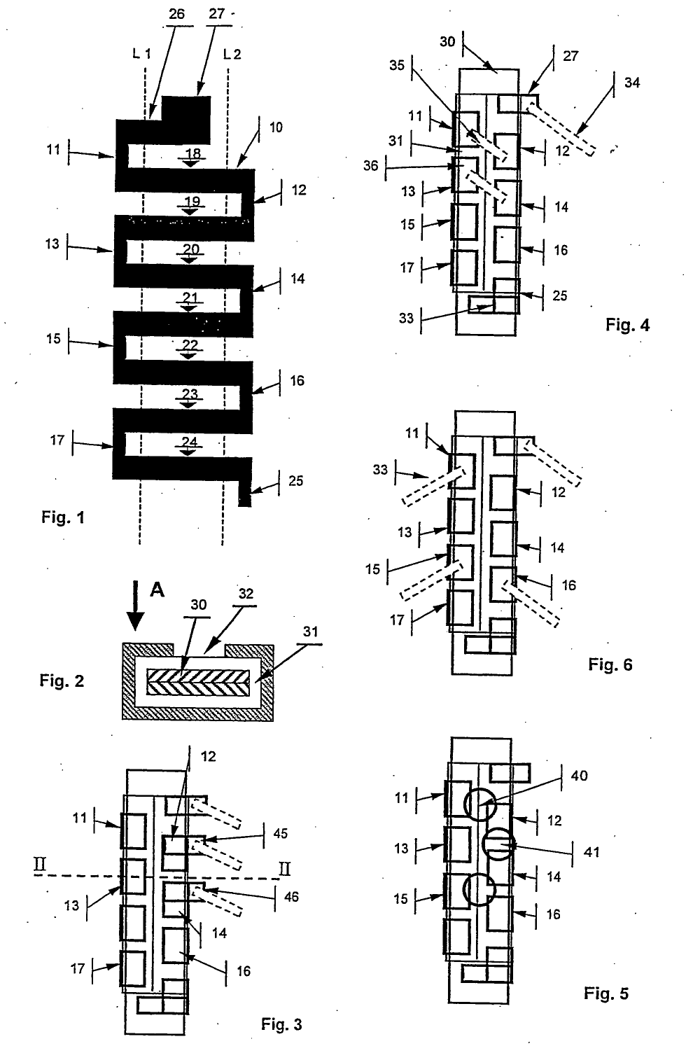

FIG. 1 shows a plan view of a heating winding having a meandering shape after the stamping process,

FIG. 2 shows a sectional view along the section line II-II in FIG. 3, and

FIGS. 3 to 6 show different refinements of the invention.

A heating winding 10 is stamped, with a meandering shape, from a high-resistivity material in the form of a metal sheet, the heating winding 10 having a plurality of first longitudinal webs 11, 13, 15, 17 and second longitudinal webs 12, 14, 16, which are each positioned in a line, which two lines, denoted by L1 and L2, run parallel to one another. A transverse web 18, which runs at right angles to the lines L1, L2, adjoins one end of the longitudinal web 11, and one end of the longitudinal web 13, which is adjacent to the longitudinal web 11, adjoins the other end of the longitudinal web 12 via a transverse web 19. In this manner, the longitudinal webs 13 and 14, 14 and 15, 15 and 16, 16 and 17 are alternately connected to one another by transverse webs 20, 21, 22, 23; a further transverse web 24 adjoins the free end of the longitudinal web 17 and bears a lug 25, which runs in the longitudinal direction of the line L2 and to which a conductor can be connected. In a corresponding manner, a lug 27 is arranged on a third transverse web 26, to which lug a further conductor can be connected; the incoming conductor could be connected to the lug 25, for example, and the outgoing conductor of the heating winding could be connected to the lug 27.

This heating winding is folded around a bimetallic strip 30, as illustrated in FIG. 2. An intermediate insulating layer 31 in the form of an insulating bush is laid around the bimetallic strip 30 and is produced, for example, from a glass-fiber material. The longitudinal webs 11, 13, 15 and 17 and 12, 14, 16 are folded around this intermediate insulating layer 31 such that the outer (in FIG. 1) edges of the longitudinal webs now rest on the flat side 32 of the intermediate insulating layer 31.

FIG. 4 shows a plan view in accordance with the arrow direction A. The intermediate insulating layer 31 is wound around the bimetallic strip 30, and the longitudinal webs 11, 13, 15, 17 and the longitudinal webs 12, 14, 16, together with the tab, are located on the flat side 32 of the insulating layer.

This arrangement of the heating winding is identical for all tripping tasks in question. The incoming line 33 is illustrated by an arrow P and is terminated at the lug 25, whereas the outgoing line 34 is connected to the lug 27 and is in this case in the form of a braided wire.

In order to match this thermal release to the corresponding tripping tasks, the longitudinal webs 11 and 12 are connected to a connecting conductor section 35, and the longitudinal webs 13 and 14 are connected to a further conductor section 36. In addition, the sections 15 and 16 could also be connected to a conductor section. The transverse webs 18 and 20 are short-circuited by the conductor sections 35 and 36, with the result that the current no longer flows via the transverse webs 18 and 20, as a result of which the total resistance of the heating wire is altered.

FIG. 5 shows a further refinement of the invention; therein, the two longitudinal webs 11 and 12 are connected to one another by means a welded joint 40; also illustrated is a welded joint 41 between the longitudinal webs 12 and 14, as a result of which the two transverse webs 19 and 20 and the longitudinal web 13 are disconnected from the heating winding. It is naturally also possible for three longitudinal webs to be connected to one another, namely the longitudinal webs 15, 16 and 14, as illustrated, by means of the welded joint 41a, as a result of which a corresponding change to the resistance of the heating winding is likewise brought about.

FIG. 3 shows a further embodiment of the invention. In this case, connection tabs or projections 45 and 46 are integrally formed on the longitudinal webs 12 and 14, with the result that the incoming line is connected, for example, to the longitudinal web 14, as a result of which only the longitudinal webs 11, 12 and 13 are connected into the current flow.

Instead of providing protrusions 45 and 46, the individual feed conductors 33 can either be connected to the longitudinal web 11 or to the longitudinal web 15 or to the longitudinal web 16.

1. A thermal overcurrent release, which is heated indirectly by means of a heating winding, having a tripping strip consisting of a bimetallic strip, a shape memory alloy or the like, an intermediate insulating layer being inserted between the heating winding and the tripping strip, and one of the ends of the heating winding being connected to a feed conductor, wherein the heating winding has an identical, meandering design for all current levels and is folded around the intermediate insulating layer, and in that, in order to change the resistance of the heating winding for other current levels, the outgoing line is connected to a tapping point between the ends of the heating winding.

2. A thermal overcurrent release, which is heated indirectly by means of a heating winding, having a tripping strip consisting of a bimetallic strip, a shape memory alloy or the like, an intermediate insulating layer being inserted between the heating winding and the tripping strip, and one of the ends of the heating winding being connected to a feed conductor, wherein the heating winding has an identical, meandering design for all current levels and is folded around the intermediate insulating layer, and in that, in order to carry out the change, the outgoing line is connected to the other end of the heating winding, and at least two adjacent turns are short-circuited.

3. The release as claimed in claim 2, wherein the adjacent turns are short-circuited by a welded joint and/or by means of a conductor section.
